(19) United States
(12) Patent Application Publication
(10) Pub. No.: US 2022/0092027 A1
(43) Pub. Date: Mar. 24, 2022

(54) INFORMATION PROCESSING APPARATUS AND NON-TRANSITORY COMPUTER READABLE MEDIUM

(71) Applicant: FUJIFILM BUSINESS INNOVATION CORP., Tokyo (JP)

(72) Inventor: Toshihide FUJII, Kanagawa (JP)

(73) Assignee: FUJIFILM BUSINESS INNOVATION CORP., Tokyo (JP)

(21) Appl. No.: 17/182,751

(22) Filed: Feb. 23, 2021

(30) Foreign Application Priority Data
Sep. 23, 2020 (JP) 2020-159116

(51) Int. Cl. G06F 16/16; G06F 16/93; G06F 16/185

(52) U.S. Cl. CPC G06F 16/164; G06F 16/185; G06F 16/93

(57) ABSTRACT

An information processing apparatus includes a processor configured to, in response to storage of a new file in a storage location storing an existing file given a user-set attribute name, which is an attribute name of the file set by a user, and an attribute value corresponding to the user-set attribute name, set the user-set attribute name set to the existing file to the new file.

### CROSS-REFERENCE TO RELATED APPLICATIONS

This application is based on and claims priority under 35 USC 119 from Japanese Patent Application No. 2020-159116 filed Sep. 23, 2020.

### BACKGROUND

### (i) Technical Field

The present disclosure relates to an information processing apparatus and a non-transitory computer readable medium.

### (ii) Related Art

Japanese Patent No. 5243054 discloses a data management system for tax accounting tasks, which classifies and saves document data regarding tax accounting read by a reading apparatus. The system includes: a memory area where document data is registered; a table storage area that stores one or more tables in which a keyword related to a registration location of document data is registered; a character recognizing unit that converts image data of the read document to text information; a text search unit that searches text information of the document data for a keyword in the one or more tables; and a registration destination determining unit that determines a registration location of the document data or a candidate therefor using search information output from the text search unit. In the one or more tables stored in the table storage area, at least a first association relationship that associates a task folder and a document category, and a second association relationship that associates the document category and a keyword related to each document category are registered. In the memory area, one or more task folders corresponding to a document category are provided below a company folder provided for each company. The registration destination determining unit refers to the second association relationship and extracts a document category of the document data based on at least one of (1) a keyword that is most frequently detected in a document file, (2) a keyword that hits first in the document file, and (3) a keyword whose value obtained by multiplying the number of times the keyword is detected by a weight value for the keyword is largest. The registration destination determining unit refers to the first association relationship and extracts a corresponding task folder from the extracted document category, thereby determining in which task folder the document data should be registered.

There is a document management system that, in order to facilitate management of documents, manages each document after a user freely sets an attribute to the document in accordance with the document's characteristics. The attribute of a document is represented by an attribute name, which is the name of the attribute, and an attribute value, which is the value thereof. Hereinafter, an attribute name set by a user will be referred to as a user-set attribute name.

### SUMMARY

Aspects of non-limiting embodiments of the present disclosure relate to providing an information processing apparatus and a non-transitory computer readable medium which may simplify the giving of a user-set attribute name, compared to the case in which a user individually enters and sets, to each file managed in a file management system, the entirety of a user-set attribute name that should be given to the file.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to, in response to storage of a new file in a storage location storing an existing file given a user-set attribute name, which is an attribute name of the file set by a user, and an attribute value corresponding to the user-set attribute name, set the user-set attribute name set to the existing file to the new file.

### BRIEF DESCRIPTION OF THE DRAWINGS

An exemplary embodiment of the present disclosure will be described in detail based on the following figures, wherein:

FIG. 1 is a diagram illustrating an example of the schematic configuration of a file management system;

FIG. 2 is a block diagram illustrating the hardware configuration of an information processing apparatus;

FIG. 3 is a flowchart illustrating an example of an information process;

FIG. 4 is a diagram illustrating an example in which a user performs a process of registering a new file with no attribute in a folder;

FIG. 5 is a diagram illustrating an example of a process of scrutinizing the attribute of each file immediately below a folder selected by the user;

FIG. 6 is a diagram illustrating an example of a process of requesting the user to enter an attribute value;

FIG. 7 is a diagram illustrating an example in which the user performs a process of registering a new file with an attribute in a folder;

FIG. 8 is a diagram illustrating an example of a process of extracting a folder including the largest number of files with the attribute;

FIG. 9 is a diagram illustrating an example in which the folder including the largest number of files with the attribute is displayed to the user to receive an entry as to whether the folder serves as a storage location;

FIG. 10 is a diagram illustrating an example of a file registration destination change report;

FIG. 11 is a diagram illustrating an example of a process of requesting the user to enter an attribute value;

FIG. 12 is a diagram illustrating an example of presentation in the case where a user-set attribute name and an attribute value are set; and

FIG. 13 is a diagram illustrating an example of presentation in the case where a user-set attribute name and an attribute value are set, in which the attribute value is changeable.

### DETAILED DESCRIPTION

Hereinafter, an exemplary embodiment will be described with reference to the drawings. Note that the same elements and the same processes are given the same reference numerals throughout the drawings, and overlapping descriptions are omitted.

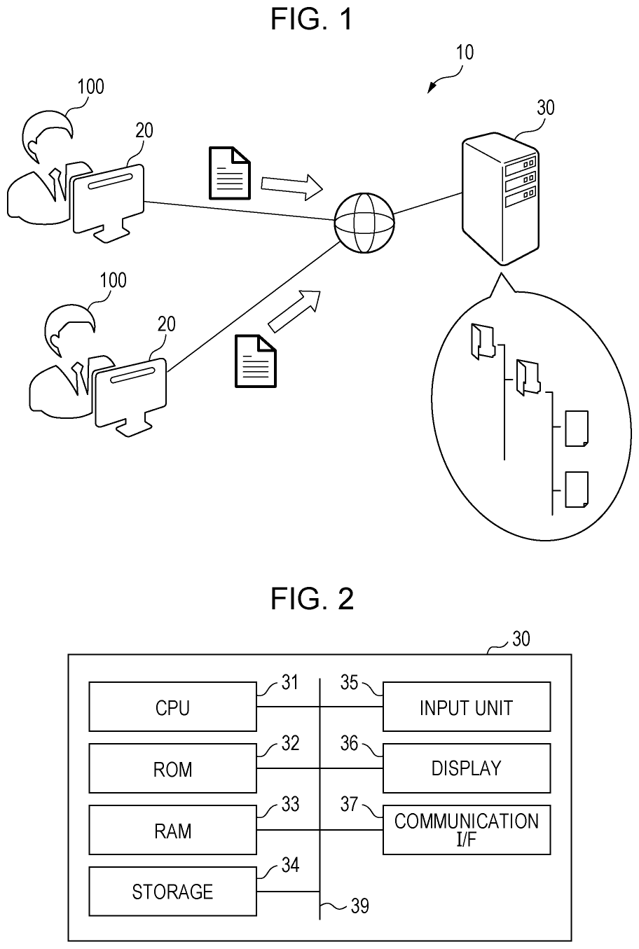

FIG. 1 is a diagram illustrating a schematic configuration of a file management system according to the present exemplary embodiment.

FIG. 1 is a diagram illustrating a schematic configuration of a file management system 10 including an information processing apparatus 30 according to the present exemplary embodiment.

As illustrated in FIG. 1, the file management system 10 is configured by connecting a user terminal apparatus 20, which is used by a user 100, and the information processing apparatus 30, which serves as a server apparatus, to a communication unit such as a network. As the communication unit, various networks such as the Internet and Ethernet (registered trademark) are applicable, as will be described later. Although FIG. 1 illustrates an example where there are two users 100, two user terminal apparatuses 20, and one information processing apparatus 30, the numbers thereof are not limited to these numbers.

FIG. 2 is a block diagram illustrating the hardware configuration of the information processing apparatus 30.

As illustrated in FIG. 2, the information processing apparatus 30 has the functions as a computer and includes the following: a central processing unit (CPU) 31, which is an example of a processor; read-only memory (ROM) 32; random-access memory (RAM) 33; a storage 34; an input unit 35, which serves as a user interface; a display 36, which is a liquid crystal display; and a communication interface (I/F) 37. These units of the information processing apparatus 30 are connected to each other via a bus 39 to be able to communicate with each other.

The CPU 31, which is an example of a processor, is a central processing unit, and executes various programs and controls the individual units. That is, the CPU 31 reads a program from the ROM 32 or the storage 34, and executes the program using the RAM 33 as a work area. In accordance with a program recorded in the ROM 32 or the storage 34, the CPU 31 controls each unit of the information processing apparatus 30 and performs various types of arithmetic processing.

The ROM 32 stores various programs and various data. As a work area, the RAM 33 temporarily stores a program or data. The storage 34 includes a storage device such as a hard disk drive (HDD) or a solid state drive (SSD), and stores various programs including an operating system, and various data.

The input unit 35, which serves as a user interface, is an interface when the server administrator uses the information processing apparatus 30, and is the input unit 35 such as a button, a touchscreen, and/or the like. The display 36 includes a liquid crystal display or the like.

The communication interface 37 is an interface for communicating with each user terminal apparatus 20 such as a personal computer. A wired or wireless communication system is used for the communication interface 37. As the communication standard of the communication interface 37, for example, Ethernet (registered trademark), Fiber Distributed Data Interface (FDDI), Wi-Fi (registered trademark), or the like is used.

When executing the above-mentioned program, the information processing apparatus 30 uses the above-described hardware resources to implement various functions.

The information processing apparatus 30 according to the present exemplary embodiment includes the CPU 31, which serves as a processor, as described above.

In response to storage of a new file in a storage location storing an existing file given a user-set attribute name, which is the attribute name of the file set by the user, and an attribute value corresponding to the user-set attribute name, the CPU 31 sets the user-set attribute name set to the existing file to the new file.

In the present exemplary embodiment, a plurality of existing files are registered in a folder serving as a storage location registered for a new file.

The CPU 31 sets a user-set attribute name that is common among at least some of the plurality of existing files to the new file.

Furthermore, the CPU 31 sets the common user-set attribute name to the new file, receives an entry of an attribute value associated with the set user-set attribute name, and sets the entered attribute value to the new file.

Furthermore, the CPU 31 sets an attribute value that is associated with the common user-set attribute name among existing files and that is common among the largest number of existing files to the new file.

In addition, the CPU 31 presents a storage location including the largest number of files to which a user-set attribute name common to the user-set attribute name set to the new file is set.

The CPU 31 presents a storage location including the largest number of files to which a user-set attribute name and an attribute value common to a user-set attribute name set to the new file and to an attribute value corresponding to the user-set attribute name are set.

In addition, in the case where the storage location where the new file is stored and the presented storage location are different, the CPU 31 receives an entry as to whether to store the new file in the presented storage location. On receipt of an entry to store the new file in the presented storage location, the CPU 31 stores the new file in the presented storage location, and sets a user-set attribute name set to an existing file that is already stored in the presented storage location to the new file.

In the present exemplary embodiment, an information processing program for causing a computer to function as the above-mentioned information processing apparatus is stored in the ROM 32 or the storage 34.

The CPU 31 is configured to read the above-mentioned information processing program from the ROM 32 or the storage 34, and execute the program using the RAM 33 as a work area.

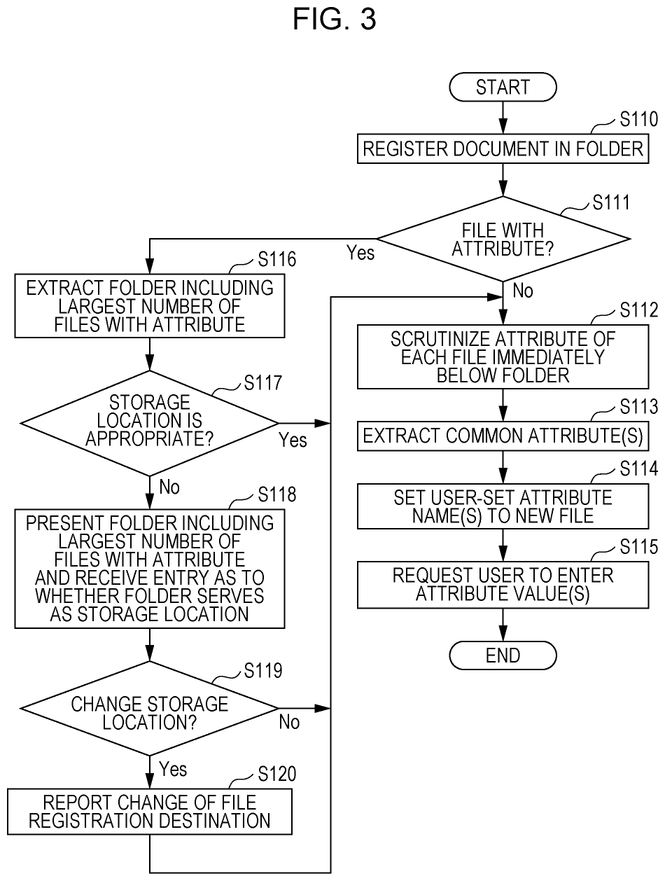

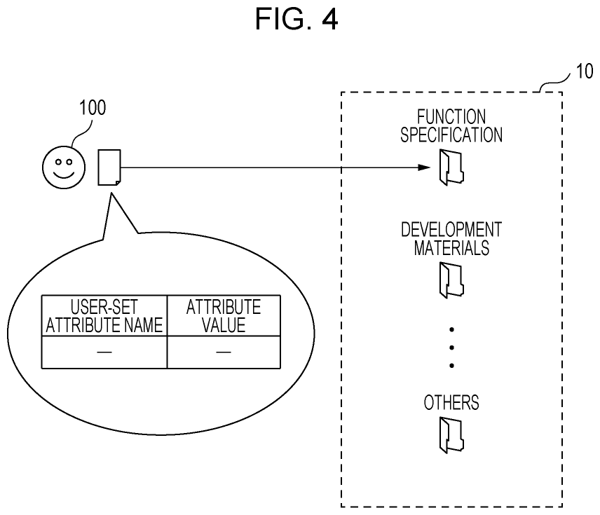

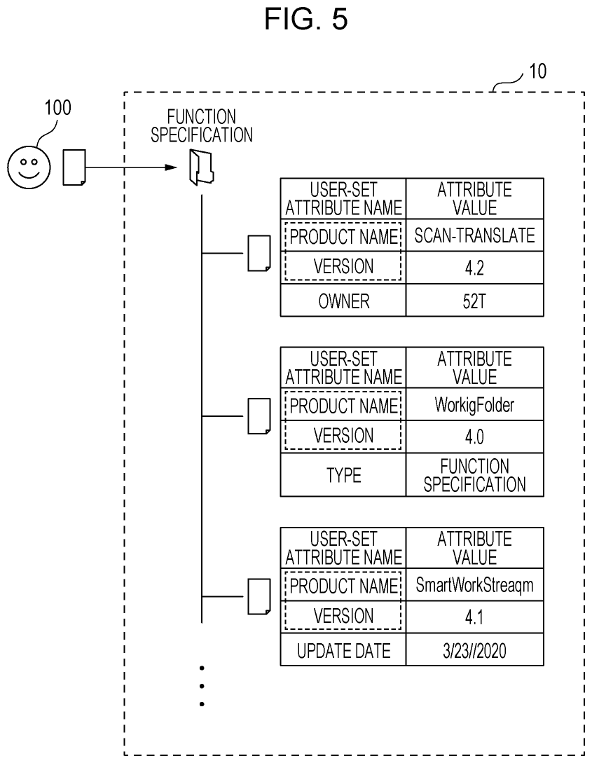

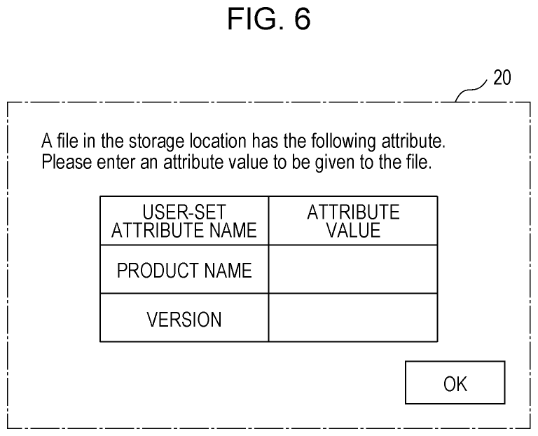

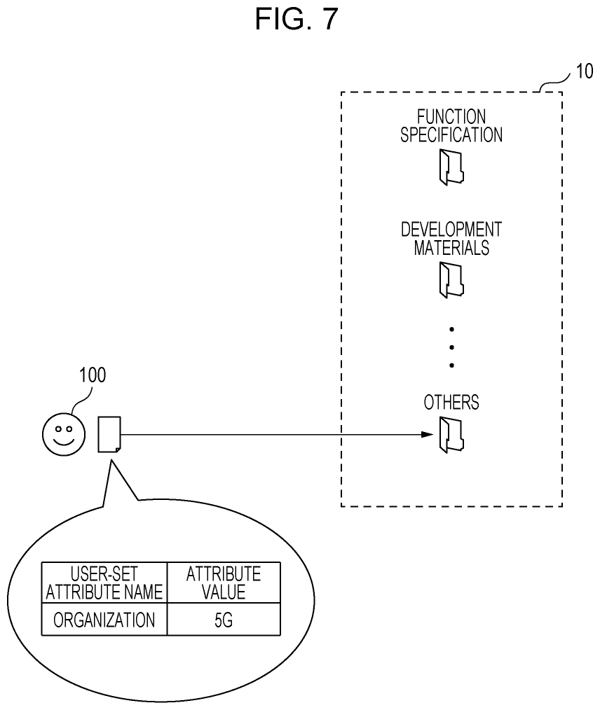

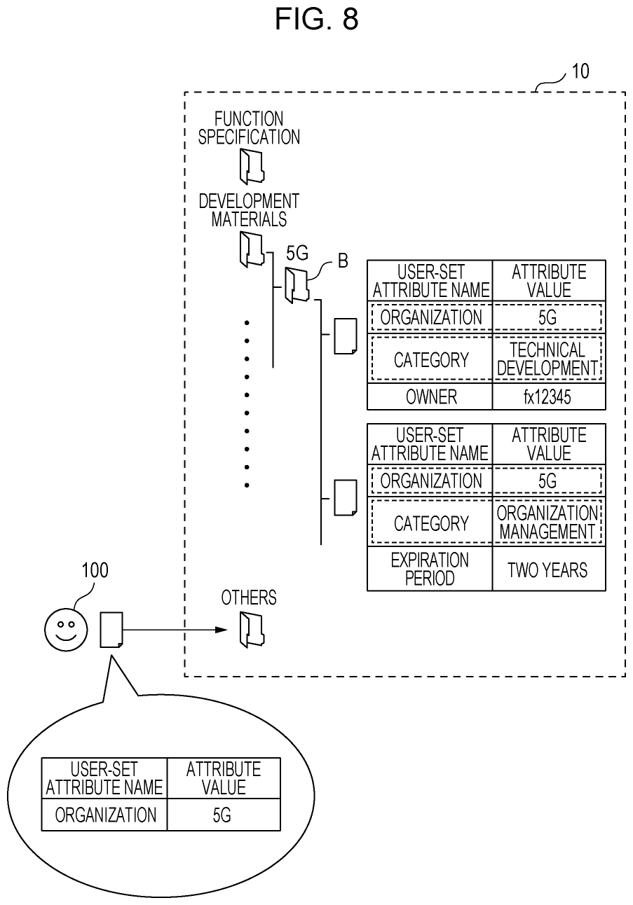

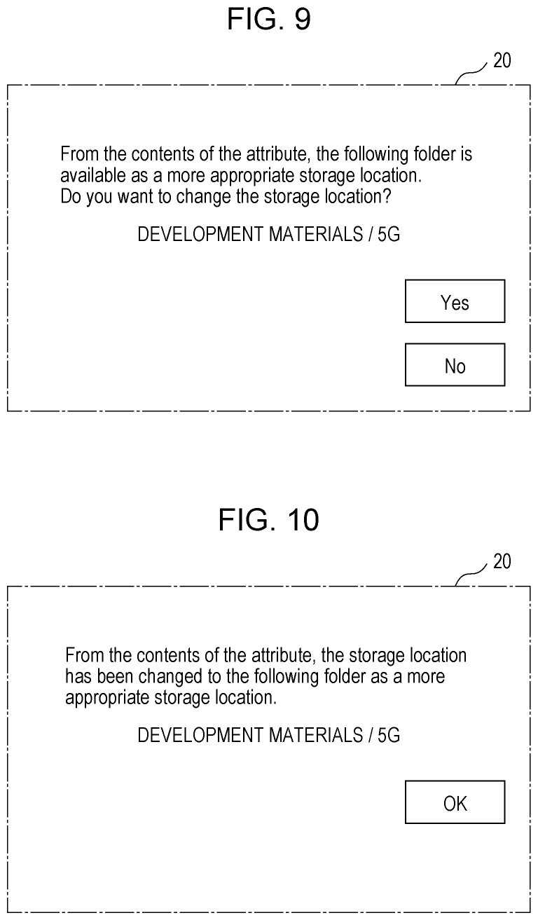

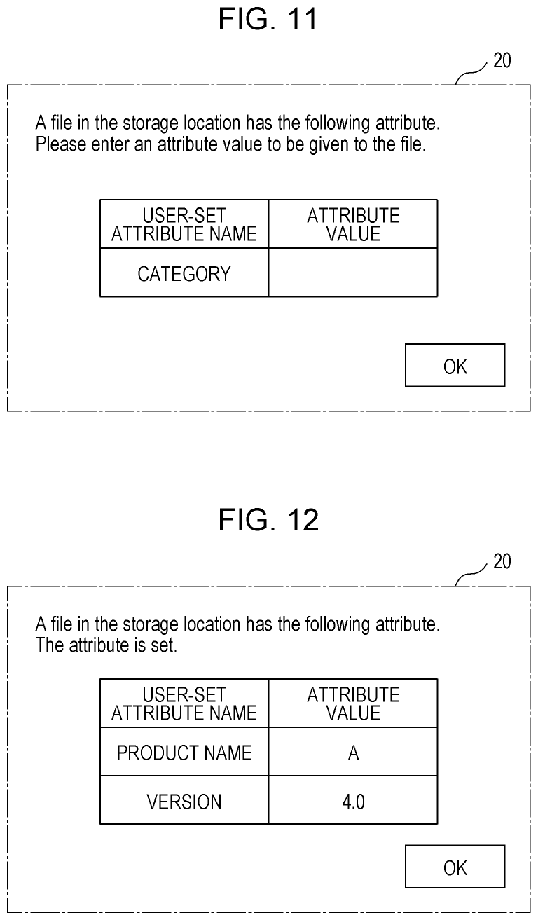

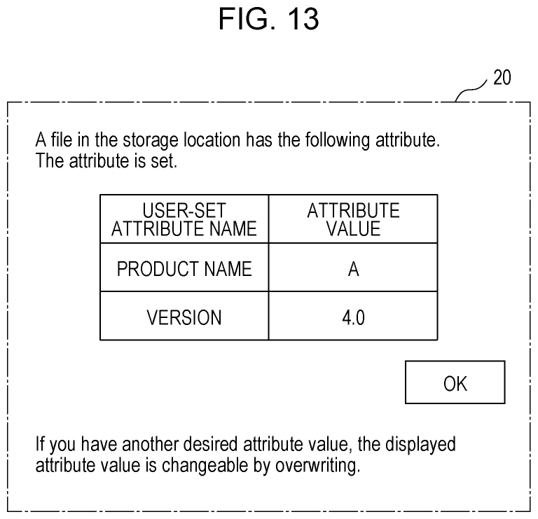

Next, the operation of the information processing apparatus 30 will be described. FIG. 3 is a flowchart illustrating the flow of an information process performed by the information processing apparatus 30. FIG. 4 is a diagram illustrating an example in which the user performs a process of registering a new file with no attribute in a folder. FIG. 5 is a diagram illustrating an example of a process of scrutinizing the attribute of each file immediately below a folder selected by the user. FIG. 6 is a diagram illustrating an example of a process of requesting the user to enter an attribute value. FIG. 7 is a diagram illustrating an example in which the user performs a process of registering a new file with an attribute in a folder. FIG. 8 is a diagram illustrating an example of a process of extracting a folder including the largest number of files with the attribute. FIG. 9 is a diagram illustrating an example in which the folder including the largest number of files with the attribute is displayed to the user to receive an entry as to whether the folder serves as a storage location. FIG. 10 is a diagram illustrating an example of a file registration destination change report. FIG. 11 is a diagram illustrating an example of a process of requesting the user to enter an attribute value. FIG. 12 is a diagram illustrating an example of presentation in the case where a user-set attribute name and an attribute value are set. FIG. 13 is a diagram illustrating an example of presentation in the case where a user-set attribute name and an attribute value are set, in which the attribute value is changeable.

In step S110, the CPU 31 newly registers a file specified by the user in a folder which is the storage location. For example, the user 100 accesses the storage 34 of the information processing apparatus 30 from his/her user terminal apparatus 20, selects a desired a folder while referring to a directory and the like, and gives a command to save a desired file. In response to the command, the CPU 31 registers the file. Hereinafter, a newly registered file will be referred to as a new file.

In step S111, the CPU 31 determines whether the new file of the user 100 has an attribute. In the case where it is determined that the file has no attribute (NO in step S111), the CPU 31 proceeds to step S112; and, in the case where it is determined that the file has an attribute (YES in step S111), the CPU 31 proceeds to step S116.

In step S112, the CPU 31 scrutinizes the attribute of each file immediately below the folder where the new file is registered.

Specifically, for example, as illustrated in FIG. 4, the case in which a new file to which the user 100 has given neither a user-set attribute name nor an attribute value is registered in a folder with the name “function specification” is considered. In this case, the CPU 31 refers to the folder “function specification”, as illustrated in FIG. 5, and checks a user-set attribute name and a corresponding attribute value for all the files registered in the folder. In the present exemplary embodiment, the case in which files immediately below a folder where a new file is registered are scrutinized is discussed. However, not only files immediately below the folder, but also files in another folder registered in the folder where the new file is registered may be scrutinized. Hereinafter, a file already registered in a folder where a new file is registered will be referred to as an existing file.

In step S113, the CPU 31 extracts a user-set attribute name(s) common among existing files.

Specifically, for example, as illustrated in FIG. 5, it is assumed that the user-set attribute name “product name” and the user-set attribute name “version” are common among existing files in the folder “function specification”. In this case, the CPU 31 extracts the user-set attribute names “product name” and “version”.

If there is no common user-set attribute name among all the files, a user-set attribute name that is common among the largest number of existing files is extracted. Although a user-set attribute name common among existing files is extracted in the present exemplary embodiment, a pair of a user-set attribute name common among existing files and a corresponding attribute value may be extracted.

In step S114, the CPU 31 sets the common user-set attribute name(s), which is/are extracted in step S113, to the new file.

Specifically, for example, the CPU 31 gives “product name” and “version”, which are the common user-set attribute names extracted in FIG. 5, to the new file.

In step S115, the CPU 31 requests the user to enter an attribute value for each user-set attribute name set to the new file.

Specifically, for example, the CPU 31 displays a screen illustrated in FIG. 6 on the user terminal apparatus 20 of the user 100. The CPU 31 receives an entry of an attribute value from the user 100. In the example illustrated in FIG. 6, the CPU 31 displays a dialogue requesting an entry of an attribute value corresponding to each of “product name” and “version”, which are the user-set attribute names, on the user terminal apparatus 20.

The description now returns to the case where, in the case where it is determined in step S111 that the new file has an attribute (YES in step S111), the CPU 31 proceeds to step S116.

In the case where the file has an attribute, in step S116, the CPU 31 extracts a folder including the largest number of files with the attribute.

Specifically, for example, as illustrated in FIG. 7, the case in which the user 100 selects the folder “others” in the file management system 10 and registers a new file to which the user 100 has set “organization” as a user-set attribute name and “5G” as an attribute value is considered.

In this case, for example, as illustrated in FIG. 8, the CPU 31 extracts a folder B (development materials/5G) including the largest number of files with the same attribute as the attribute (user-set attribute name “organization” and attribute value “5G”) set to the new file.

If there are multiple folders including the largest number of files with the attribute and these folders are hierarchically arranged, the CPU 31 is set to extract, for example, a lower-layer folder or a higher-layer folder.

In step S117, the CPU 31 determines whether the storage location of the new file is appropriate. Specifically, the CPU 31 determines whether the folder in which the user 100 has registered the new file in step S110 matches the folder extracted in step S116. In the case where the two folders match (YES in step 117), the CPU 31 determines that the storage location is appropriate, and proceeds to step S112. The process from step S112 onward is as described above. In contrast, in the case where the two folders do not match (NO in step S117), the CPU 31 determines that the storage location is inappropriate, and proceeds to the next step S118.

In step S118, the CPU 31 presents the folder extracted in step S112 to the user 100, and receives an entry as to whether the extracted folder serves as a storage location.

Specifically, for example, as illustrated in FIG. 9, the CPU 31 displays “From the contents of the attribute, the following folder is available as a more appropriate storage location. Do you want to change the storage location?” on the user terminal apparatus 20, and presents the folder “development materials/5G” as an appropriate storage location. In addition, the CPU 31 displays the “YES” and “NO” buttons. By selecting “YES”, the user 100 accepts to change the storage location of the new file to the presented storage location; and, by selecting “NO”, the user 100 rejects to change the storage location of the new file to the presented storage location.

In the above-described example, the CPU 31 presents a folder including the largest number of files to which a pair of a user-set attribute name and an attribute value common to the pair of the user-set attribute name of the new file and an attribute value corresponding to this user-set attribute name is set. However, there is no particular restriction on a to-be-presented folder. For example, focusing only on the user-set attribute name, the CPU 31 may present a folder including the largest number of files whose user-set attribute name is common to that of the new file.

In step S119, the CPU 31 determines whether to change the storage location. Whether to change the storage location depends on, as described above, for example, whether “YES” or “NO” has been selected on the screen illustrated in FIG. 9. In the case where “YES” has been selected, the CPU 31 determines to change the storage location; and, in the case where “NO” has been selected, the CPU 31 determines not to change the storage location. In the case where it is determined not to change the storage location (NO in step S119), the CPU 31 proceeds to step S112. The process from step S112 onward is as described above. In contrast, in the case where it is determined to change the storage location (YES in step S119), the CPU 31 proceeds to step S120.

In step S120, the CPU 31 reports a change of the registration destination of the new file.

Specifically, for example, the CPU 31 displays the dialogue “From the contents of the attribute, the storage location has been changed to the following folder as a more appropriate storage location.” on the user terminal apparatus 20, as illustrated in FIG. 10, and presents the folder “development materials/5G” as a new storage location. The user 100 may select “OK” after checking the new storage location.

In the present exemplary embodiment, in step S115, for example, as illustrated in FIG. 6, the user 100 is requested to enter an attribute value. However, there is no particular restriction on how an attribute value is entered. An attribute value may be entered automatically. In this case, for example, the CPU 31 extracts a pair of a user-set attribute name common among existing files and a corresponding attribute value, sets the user-set attribute name of the extracted pair to the new file in step S114, and additionally sets the attribute value of the pair to the new file. In this case, the CPU 31 displays a screen as illustrated in FIG. 12 on the user terminal apparatus 20, thereby allowing the user 100 to recognize a user-set attribute name and an attribute value automatically set to the new file. In the case of automatically setting a user-set attribute name as well as an attribute value, the CPU 31 extracts, in step S116, a folder including the largest number of files to which a pair of a user-set attribute name and an attribute value common to the pair of a user-set attribute name set to the new file and a corresponding attribute value is set. In step S118, the CPU 31 preferably presents a folder including the largest number of files to which a pair of a user-set attribute name and an attribute value common to that of the new file is set.

Furthermore, in the case where the above-mentioned user-set attribute name and attribute value are set, the user 100 may be allowed to change the attribute value. In this case, the CPU 31 displays a dialogue as illustrated in FIG. 13 on the user terminal apparatus 20, and receives editing of the attribute value by the user 100. On the screen illustrated in FIG. 13, both the user-set attribute name and the attribute value may be editable. Alternatively, in FIG. 13, the user 100 may be allowed to select not to adopt the automatically-set user-set attribute name and attribute value. In this case, for example, the “adopt none” button may be displayed on the screen illustrated in FIG. 13.

The present disclosure is not limited to the above-mentioned exemplary embodiment, and various modifications, changes, and improvements may be made without departing from the gist thereof. For example, some of the above-described exemplary embodiments may be combined as appropriate.

Although the exemplary case of implementing each process by software has been described in the present exemplary embodiment, a process equivalent to the flowchart of each process may be implemented by hardware by mounting, for example, an application-specific integrated circuit (ASIC). In this case, the processing speed is increased, as compared to the case where each process is implemented by software.

Although the mode in which an information processing program is installed in ROM or the like has been described in the above-described exemplary embodiment, the mode is not limited to the above mode. An information processing program according to the present disclosure may be provided by being recorded in a computer-readable storage medium. For example, an information processing program according to the present disclosure may be provided by being recorded in an optical disc such as a compact-disc (CD)-ROM or a digital versatile disc (DVD)-ROM. In addition, an information processing program according to the present disclosure may be provided by being recorded in semiconductor memory such as universal serial bus (USB) memory or flash memory. Furthermore, the information processing apparatus 30 may obtain a program through a communication line from an external apparatus connected to the communication line.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
in response to storage of a new file in a storage location storing an existing file given a user-set attribute name, which is an attribute name of the file set by a user, and an attribute value corresponding to the user-set attribute name, set the user-set attribute name set to the existing file to the new file.

2. The information processing apparatus according to claim 1, wherein:
a plurality of existing files are registered in the storage location, and
the processor is configured to set a user-set attribute name that is common among at least some of the plurality of existing files to the new file.

3. The information processing apparatus according to claim 2, wherein the processor is configured to receive an entry of an attribute value associated with the user-set attribute name set to the new file, and to set the entered attribute value to the new file.

4. The information processing apparatus according to claim 2, wherein the processor is further configured to set an attribute value that is associated with the common user-set attribute name among existing files and that is common to a largest number of existing files to the new file.

5. The information processing apparatus according to claim 1, wherein the processor is configured to present a storage location including a largest number of files to which a user-set attribute name common to the user-set attribute name set to the new file is set.

6. The information processing apparatus according to claim 2, wherein the processor is configured to present a storage location including a largest number of files to which a user-set attribute name common to the user-set attribute name set to the new file is set.

7. The information processing apparatus according to claim 3, wherein the processor is configured to present a storage location including a largest number of files to which a user-set attribute name common to the user-set attribute name set to the new file is set.

8. The information processing apparatus according to claim 4, wherein the processor is configured to present a storage location including a largest number of files to which a user-set attribute name common to the user-set attribute name set to the new file is set.

9. The information processing apparatus according to claim 1, wherein the processor is configured to present a storage location including a largest number of files to which a user-set attribute name and an attribute value common to the user-set attribute name set to the new file and to an attribute value corresponding to the user-set attribute value are set.

10. The information processing apparatus according to claim 2, wherein the processor is configured to present a storage location including a largest number of files to which a user-set attribute name and an attribute value common to the user-set attribute name set to the new file and to an attribute value corresponding to the user-set attribute value are set.

11. The information processing apparatus according to claim 3, wherein the processor is configured to present a storage location including a largest number of files to which a user-set attribute name and an attribute value common to the user-set attribute name set to the new file and to an attribute value corresponding to the user-set attribute value are set.

12. The information processing apparatus according to claim 4, wherein the processor is configured to present a storage location including a largest number of files to which a user-set attribute name and an attribute value common to the user-set attribute name set to the new file and to an attribute value corresponding to the user-set attribute value are set.

13. The information processing apparatus according to claim 5, wherein the processor is configured to:
in a case where a storage location where the new file is stored and the presented storage location are different, receive an entry as to whether to store the new file in the presented storage location;
on receipt of an entry to store the new file in the presented storage location, store the new file in the presented storage location; and
set a user-set attribute name set to an existing file already stored in the presented storage location to the new file.

14. The information processing apparatus according to claim 6, wherein the processor is configured to:
in a case where a storage location where the new file is stored and the presented storage location are different, receive an entry as to whether to store the new file in the presented storage location;
on receipt of an entry to store the new file in the presented storage location, store the new file in the presented storage location; and
set a user-set attribute name set to an existing file already stored in the presented storage location to the new file.

15. The information processing apparatus according to claim 7, wherein the processor is configured to:
in a case where a storage location where the new file is stored and the presented storage location are different, receive an entry as to whether to store the new file in the presented storage location;
on receipt of an entry to store the new file in the presented storage location, store the new file in the presented storage location; and
set a user-set attribute name set to an existing file already stored in the presented storage location to the new file.

16. The information processing apparatus according to claim 8, wherein the processor is configured to:
in a case where a storage location where the new file is stored and the presented storage location are different, receive an entry as to whether to store the new file in the presented storage location;
on receipt of an entry to store the new file in the presented storage location, store the new file in the presented storage location; and
set a user-set attribute name set to an existing file already stored in the presented storage location to the new file.

17. The information processing apparatus according to claim 9, wherein the processor is configured to:
in a case where a storage location where the new file is stored and the presented storage location are different, receive an entry as to whether to store the new file in the presented storage location;
on receipt of an entry to store the new file in the presented storage location, store the new file in the presented storage location; and
set a user-set attribute name set to an existing file already stored in the presented storage location to the new file.

18. The information processing apparatus according to claim 10, wherein the processor is configured to:
in a case where a storage location where the new file is stored and the presented storage location are different, receive an entry as to whether to store the new file in the presented storage location;
on receipt of an entry to store the new file in the presented storage location, store the new file in the presented storage location; and
set a user-set attribute name set to an existing file already stored in the presented storage location to the new file.

19. The information processing apparatus according to claim 11, wherein the processor is configured to:
in a case where a storage location where the new file is stored and the presented storage location are different, receive an entry as to whether to store the new file in the presented storage location;
on receipt of an entry to store the new file in the presented storage location, store the new file in the presented storage location; and
set a user-set attribute name set to an existing file already stored in the presented storage location to the new file.

20. A non-transitory computer readable medium storing a program causing a computer to function as the information processing apparatus according to claim 1.
